(19) United States
(12) Patent Application Publication
(10) Pub. No.: US 2010/0098071 A1
(43) Pub. Date: Apr. 22, 2010

(54) METHOD AND NETWORK FOR FORWARDING PACKET OF RESILIENT PACKET RING

(75) Inventor: Zhongkai Zhang, Guangdong Province (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Guangdong Province (CN)

(21) Appl. No.: 11/993,445

(22) PCT Filed: Apr. 26, 2007
(86) PCT No.: PCT/CN2007/001399

§ 371 Date: Dec. 20, 2007

(30) Foreign Application Priority Data
Jul. 14, 2006 (CN) 200610061668.2

(51) Int. Cl. H04L 12/56

(52) U.S. Cl. 370/389

(57) ABSTRACT

Method for transmitting packet in resilient packet intersect ring includes: at least two resilient packet intersect ring intersect each other on two intersect node, the intersect node receives a broadcast packet from the first resilient packet ring, and copies the said broadcast packet; the said intersect node judges whether allowing to insert the said broadcast packet into the second resilient packet ring by spanning the ring according to the identification information included in the said copied broadcast packet, if so, inserting into the second resilient packet ring by spanning the ring and broadcasting, otherwise, discarding the said broadcast packet, the control condition of allowing to broadcast by spanning the ring of all intersect nodes is null. The invention can ensure that when all intersect nodes can transmit spanning ring server, it avoids spanning ring broadcast storm. The invention is applied to the case that several resilient packet rings intersect each other. The invention is easy to be implemented. It has good compatibility with the existing networks. Its cast is very low.

This application claims the benefit of priority from China patent application No. 200610061668.2 filed on Jul. 14, 2006, titled “Intersection Station and Method for Avoiding Broadcast Storm of the Resilient Packet Intersection Ring,” the entire content of which is incorporated herein by reference.

### FIELD OF THE INVENTION

The present invention relates to the field of network communications technology, and in particular to a method and device for forwarding a packet of a Resilient Packet Ring (RPR).

### BACKGROUND OF THE INVENTION

With the development of Metropolitan Area Network (MAN), a technique standard of a Resilient Packet Ring (RPR) is proposed. FIG. 1 is a schematic diagram illustrating a topology structure of an RPR in the prior art. As shown in FIG. 1, the RPR has a reverse dual-ring topology structure including an Outer Ring and an Inner Ring, and both the Outer Ring and the Inner Ring transmit data packet and control packet. The RPR is independent of a physical layer. The physical layer may be an Ethernet or a Synchronous Digital Hierarchy (SDH). The RPR technology combines facility of the Ethernet with reliability of a Wave Division Multiplex (WDM) device. As a new MAN standard the RPR gradually gets the operators' favor due to advantages in many aspects, including an interface bandwidth, a carrier-class failure switching capacity, a high efficiency bandwidth utility, physical layer independent and so on, and each of the operators arranges the RPR in an access network.

FIG. 2 is a schematic diagram illustrating broadcasting of the RPR in the prior art. In the RPR, when a packet can not find a corresponding station in a ring, as shown in FIG. 2, the packet will be inserted to a data stream of the ring as a broadcast packet and the broadcast packet is stripped by a source station after a circulation on the ring.

It is a better networking mode to build a network with at least two intersection RPR rings for expanding a RPR function in order to achieve more service expansion and extension and be adaptive to more actual application scenarios. FIG. 3 is a schematic diagram illustrating a networking structure of two intersection RPR rings. As shown in FIG. 3, taking two RPR rings as an example, an RPR ring 1 and an RPR ring2 intersect for networking, and a station A and a station B are intersection stations.

However, according to characteristics of the RPR ring, if a packet can not find a copy station, the packet broadcasts in the RPR ring. Therefore, a problem of broadcast storm exists in an RPR ring intersection networking mode. FIG. 4 is a schematic diagram illustrating the broadcast storm of RPR intersection rings in the prior art. As shown in FIG. 4, taking the station A in the RPR ring 1 as an example, the operation principle for station B is same as that of station A, after a broadcast packet is inserted to a ring from a station Q, the broadcast packet broadcasts in the RPR ring 1 first. When the packet arrives at the station A, the packet is broadcast and copied in the RPR ring 1 continuously (as a thinner thread 41 shown in the FIG. 4, the packet is stripped by the station Q), then a copied broadcast packet is span-ring inserted to the RPR ring2 to be broadcast in the RPR ring 2. When the packet arrives at the station B, the packet is broadcast and copied in the RPR ring 2 continuously (as a thinner thread 42 shown in the FIG. 4, the packet is stripped by the station A), then a copied broadcast packet is span-ring inserted to the RPR ring 1 to be broadcast in the RPR ring 1 again. The above circulation is kept on without stopping, and this is the problem of broadcast storm existing in the RPR ring intersection networking mode.

In order to solve the above problem of broadcast storm, a method of blocking a station is generally adopted in the prior art. A blocked station no longer forwards span-ring services, but may forward services in a single RPR ring normally. FIG. 5 is a schematic diagram illustrating avoiding the broadcast storm of the RPR intersection rings in the prior art. As shown in FIG. 5, one of two intersection stations is blocked. Taking the station A as an example, when the station A is blocked, one of the intersection stations of the two RPR rings is cut down, thus the intersection rings become tangent rings. In other words, the RPR ring1 is tangent to the RPR ring 2 at the station B. When a broadcast packet appears in the RPR ring1, the broadcast packet in the RPR ring1 is stripped by the source station. After the broadcast packet is span-ring inserted to the RPR ring 2 at the station B, the broadcast packet broadcasts in the RPR ring 2. When the broadcast packet comes back to the station B, the broadcast packet is stripped because the station B is the source station. At this time, the broadcast storm may not appear since the station A is in a blocking state and can not forward span-ring services.

Although the problem of the broadcast storm is solved by blocking one of the two intersection stations of the intersection rings, the intersection rings become tangent rings, causing a problem that the two intersection stations cannot forward the span-ring packet at the same time. In addition, the existing technology may only be used to the intersection of two RPR rings and may not be applied to a case in which a plurality of RPR rings intersect.

### SUMMARY OF THE INVENTION

In one aspect according to embodiments of the present invention, a method for forwarding a packet of an RPR (resilient packet ring) intersection ring is provided so that the broadcast storm is not generated while all intersection stations of the RPR intersection ring forward span-ring services.

In another aspect according to embodiments of the present invention, a device for forwarding a packet of an RPR intersection ring is provided, so that at the broadcast storm is not generated while all intersection stations of the RPR intersection ring forward the span-ring services.

A method for forwarding a packet of RPR intersection rings, adapted to a case that at least two RPR intersection rings intersect in at least two intersection stations,

receiving, by an intersection station, a broadcast packet from a first RPR ring and copying the broadcast packet to generate a new broadcast packet; and

judging, by the intersection station, whether a copied broadcast packet is allowed to be span-ring inserted to a second RPR ring for broadcasting according to identity information carried in the copied broadcast packet; if it is allowed, span-ring inserting the broadcast packet to the second RPR ring for broadcasting; otherwise, discarding the broadcast packet.

A device for forwarding a packet of RPR intersection rings, including a configuration layer, a transport layer, a control layer and a forwarding layer, and the control layer further includes a span-ring broadcast control module, the configuration layer is adapted to send a configuration to the span-ring broadcast control module in the control layer, when the broadcast packet is transmitted into the control layer from the transport layer, the span-ring broadcast control module in the control layer determines whether the broadcast packet is allowed to be span-rings broadcast according to the configuration, if it is allowed, proceeding to the forwarding layer; otherwise, discarding the broadcast packet.

A device for forwarding a packet of RPR intersection rings includes:

a packet receiving unit adapted to receive a broadcast packet;

a packet copying unit adapted to copy the broadcast packet from a first resilient packet ring to generate a new broadcast packet;

a packet forwarding unit adapted to insert the new broadcast packet to a second resilient packet ring for broadcasting; and

a span-ring broadcast control unit adapted to control the packet forwarding unit according to the identity information carried in a copied broadcast packet.

Each of the intersection stations in the embodiments of the present invention may forward the span-ring services, so that the load balancing of the span-ring services is achieved. And according to the embodiments of the present invention, the span-ring broadcast packet is controlled by the intersection stations, and therefore the span-ring broadcast storm is avoided without affecting the packet forwarding in a single RPR ring and the receiving of broadcast packet by other network communication devices connected to each station within the single RPR ring.

### BRIEF DESCRIPTION OF THE DRAWINGS

FIG. 1 is a schematic diagram illustrating a topology structure of a Resilient Packet Ring (RPR) in the prior art;

FIG. 2 is a schematic diagram illustrating broadcasting of an RPR in the prior art;

FIG. 3 is a schematic diagram illustrating a networking structure of two RPR intersection rings in the prior art;

FIG. 4 is a schematic diagram illustrating a broadcast storm of RPR intersection rings in the prior art;

FIG. 5 is a schematic diagram illustrating avoiding the broadcast storm of the RPR intersection rings in the prior art;

FIG. 6 is a schematic diagram illustrating a structure of a device for forwarding a

FIG. 6 is a schematic diagram illustrating a structure of a device for forwarding a packet of an RPR intersection ring according to an embodiment of the present invention;

FIG. 7 is a schematic diagram illustrating a networking structure of three RPR intersection rings according to an embodiment of the present invention;

FIG. 8 is a schematic diagram illustrating a structure of another device for forwarding a packet of an RPR intersection ring according to an embodiment of the present invention;

FIG. 9 is a flow chart illustrating processing of a packet forwarding according to an embodiment of the present invention; and

FIG. 10 is a schematic diagram illustrating a broadcasting of RPR intersection rings according to an embodiment of the present invention.

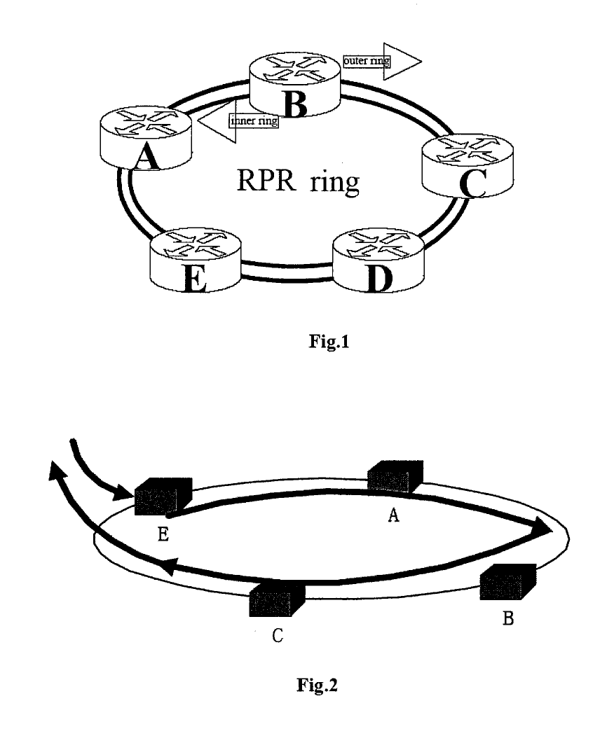

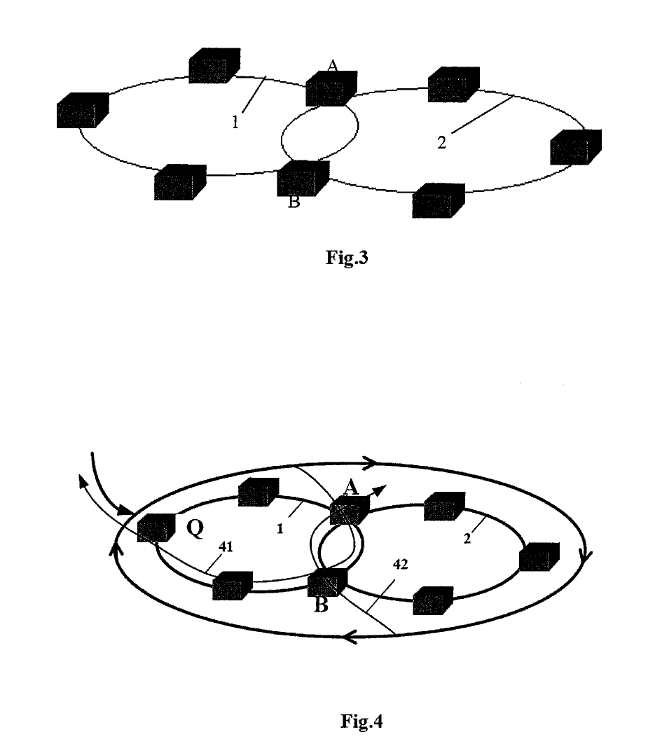

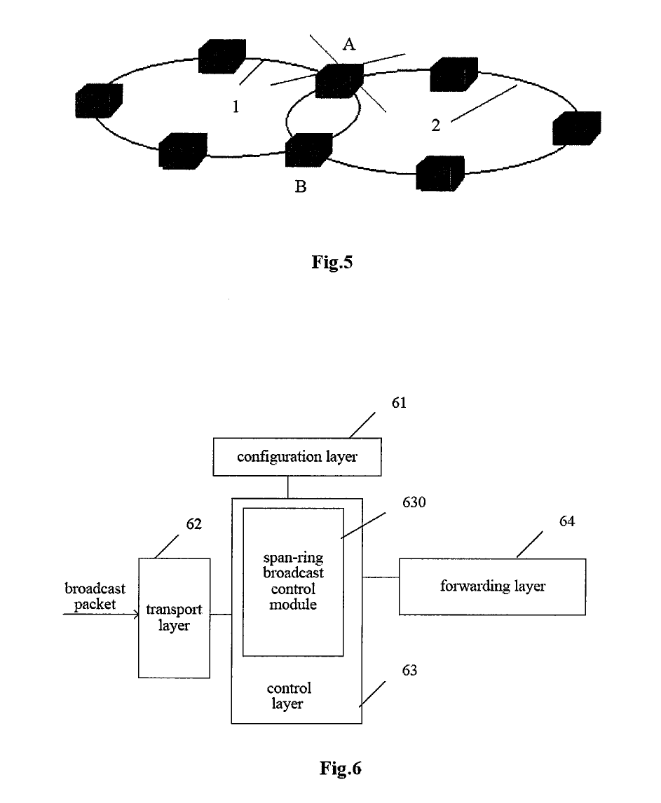

### DETAILED DESCRIPTION OF THE EMBODIMENTS

Throughout the specification, the illustrated preferred embodiments and examples are illustrative of and may not be regarded as constraints for the present invention.

A device for forwarding a packet of RPR intersection rings provided by an embodiment of the present invention is a layer 2 network device or a layer 3 network device. FIG. 6 is a schematic diagram illustrating the structure of the device for forwarding the packet of the RPR intersection ring according to an embodiment of the present invention. As shown in FIG. 6, the device includes: a configuration layer 61, a transport layer 62, a control layer 63 and a forwarding layer 64. The control layer 63 further includes a span-ring broadcast control module 630. The configuration layer 61 sends a configuration to the span-ring broadcast control module 630 in the control layer 63 to create a span-ring broadcast control table. A packet is inserted to an intersection station, which is the device for forwarding a packet of the RPR intersection ring shown in FIG. 6, from the transport layer 62. The control layer 63 controls whether the packet is allowed to be broadcast according to the span-ring broadcast control table, if the packet is allowed to be broadcast, sending the packet to the forwarding layer 64, otherwise disregarding the packet.

The span-ring broadcast control table is configured in the span-ring broadcast control module 630; when an intersection station receives a broadcast packet, the intersection station determines whether the span-ring broadcasting of the broadcast packet is allowed. The span-ring broadcast control table includes at least one of VLAN ID information, MAC address information, RPR ID information, IP address, whether allowing span-ring broadcasting and the like. By searching the span-ring broadcast control table, if the matching is successful, then the span-ring broadcasting of the broadcast packet is allowed according to the span-ring broadcast control table; otherwise, the broadcast packet is processed as default, in other words, the span-ring broadcasting of the broadcast packet is not allowed. Of course, other control modes may also be used, for example, information for forbidding the span-ring broadcast and so on is configured in the span-ring broadcast control table. By searching the span-ring broadcast control table, if the matching is successful, then the span-ring broadcasting of the broadcast packet is not allowed; otherwise, the broadcast packet is processed as default, in other words, the span-ring broadcasting of the broadcast packet is allowed.

If the span-ring broadcast control table controls the span-ring broadcast only through the VLAN ID, then whether the span-ring broadcasting of the broadcast packet is controlled merely by obtaining the VLAN ID of the broadcast packet. Similarly, the span-ring broadcast control table may control the span-ring broadcast through the MAC address information, the RPR ID information or the IP address.

If the span-ring broadcast is controlled by at least two identities in the span-ring broadcast control table, for example, the span-ring broadcast is controlled through the VLAN ID and the MAC address simultaneously; both the VLAN ID and the MAC address information need to be obtained for searching for the span-ring broadcast control table respectively. If the span-ring broadcast control table indicates to refuse, the span-ring broadcasting of the broadcast packet is not allowed; otherwise, the broadcast packet is processed as default, in other words, the span-ring broadcasting of all broadcast packets are allowed or not allowed.

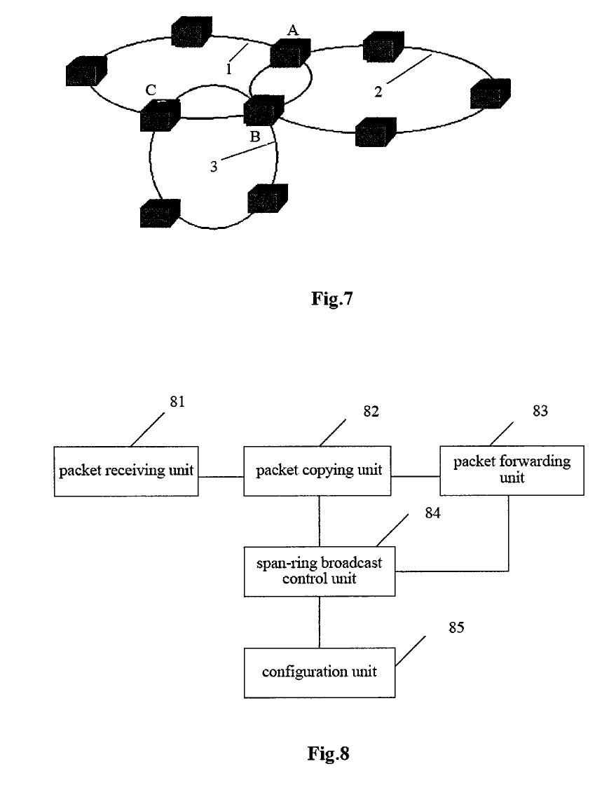

When a plurality of RPR rings intersect, as shown in FIG. 7, taking an intersection among three RPR rings as an example, the intersection stations obtained by the intersection between the RPR ring1 and the RPR ring2 include a station A and a station B, and the intersection stations obtained by the intersection between the RPR ring1 and the RPR ring3 include a station B and a station C. Then the intersection station B may have a span-ring broadcast control table for performing an identical control strategy to the broadcast packets from the RPR ring1 to the RPR ring2 and the RPR ring3, and the intersection station B also may have two span-ring broadcast control tables for controlling the broadcast packets from the RPR ring 1 to RPR ring2 and the broadcast packets from the RPR ring 1 to RPR ring3 respectively, as long as it is guaranteed that the span-ring broadcasting of one broadcast packet is allowed through at most one intersection station.

FIG. 8 is a schematic diagram illustrating a structure of another device for forwarding a packet of an RPR intersection ring provided by an embodiment of the present invention.

The device is a layer 2 network device or a layer 3 network device and is used as an intersection station of the RPR intersection rings for controlling the span-ring broadcasting of the broadcast packets from the RPR intersection rings. The device includes: a packet receiving unit 81, a packet copying unit 82, a packet forwarding unit 83 and a span-ring broadcast control unit 84.

The packet receiving unit 81 receives broadcast packets from other station devices on a first RPR ring in the RPR intersection rings. The packet copying unit 82 copies the broadcast packets to generate new broadcast packets. The operation of the packet forwarding unit 83 is controlled by the span-ring broadcast control unit 84 according to the identity information carried in the copied broadcast packets, in other words, it is controlled that whether the new broadcast packets can be inserted to a second RPR ring for broadcasting.

The identity information may be at least one of VLAN ID information, MAC address information, RPR ID information, IP address, and information for indicating whether allowing span-ring broadcasting. As described above, the information may be included in a span-ring broadcast control table preconfigured in the span-ring broadcast control unit 84. Then the span-ring broadcast control unit 84 may determine whether the span-ring broadcasting of a broadcast packet is allowed through searching the information in the span-ring broadcast control table. During searching the span-ring broadcast control table by the span-ring broadcast control unit 84, if the identity information carried in the copied broadcast packet matches the information in the span-ring broadcast control table, the span-ring broadcasting of the broadcast packet is allowed or not allowed according to the span-ring broadcast control table; otherwise, the broadcast packet is performed as default, in other words, the span-ring broadcasting of all the broadcast packets are allowed or not allowed.

If the span-ring broadcast control table controls the span-ring broadcast only through the VLAN ID, then whether the span-ring broadcasting of the broadcast packet is allowed is controlled only according to the VLAN ID of the broadcast packet. Similarly, the span-ring broadcast control table may control the span-ring broadcast through the MAC address information, the RPR ID information or the IP address.

If the span-ring broadcast is controlled by at least two identities in the span-ring broadcast control table, for example, the span-ring broadcast is controlled through the VLAN ID and the MAC address simultaneously, both the VLAN ID and the MAC address information need to be obtained for searching the span-ring broadcast control table respectively. If the span-ring broadcast control table indicates to refuse, the span-ring broadcasting of the broadcast packet is not allowed; otherwise, the broadcast packet is processed as default, in other words, the span-ring broadcasting of all broadcast packets are allowed or not allowed.

When a plurality of RPR rings intersect, the span-ring broadcast control unit 84 may store a span-ring broadcast control table for performing an identical control strategy to the broadcast packets of all the RPR rings. The span-ring broadcast control unit 84 also may have two or more span-ring broadcast control tables for controlling the broadcast packets from different RPR rings respectively, as long as it is guaranteed that the span-ring broadcasting of a broadcast packet is allowed through at most one intersection station.

For making the device according to an embodiment of the present invention to be applied to different networking environments, as shown in FIG. 8, a configuration unit 85 may be further configured in the device for transmitting configuration information to the span-ring broadcast control unit 84. The configuration information includes the control conditions for allowing the span-ring broadcasting of a broadcast packet, for example, the control condition may be the span-ring broadcast control table described above. It is obvious that by using the device for forwarding packets of the RPR intersection rings, not only the load balancing of the span-ring services may be achieved, but the span-ring broadcast storm may be avoided because each of the intersection stations on the RPR intersection rings may apply a flexible control strategy for the span-ring broadcasting of packets.

Embodiments of the present invention may be applied to a plurality of intersection RPR rings and are easy to be implemented. Embodiments of the present invention have a better compatibility with an existing network and a lower cost.

Taking a networking mode with two RPR rings as shown in FIG. 4 as an example, the method for forwarding packets of the RPR intersection rings according to an embodiment of the present invention is further described.

As shown in FIG. 4, taking two RPR rings an example, the RPR ring1 intersects the RPR ring2 for networking. The station A and station B are intersection stations. A broadcast packet carrying the VLAN information such as VLAN ID is inserted to the Station Q and is broadcast in the RPR ring1, when the broadcast packet reaches the intersection station A, the station A determines whether the broadcast packet can be inserted to the RPR ring2 for broadcasting according to the span-ring broadcast control table stored locally. Therefore, the problem of the span-ring broadcast storm is avoided.

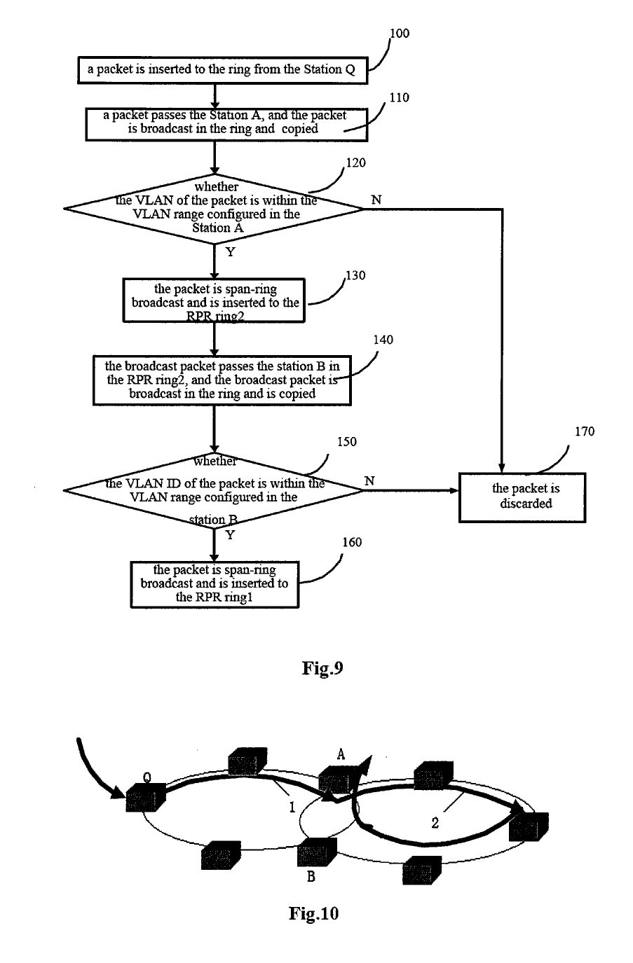

The VLAN range of the broadcast packets allowed passing is configured in the Station A and station B and the default is that all broadcast packets are not allowed to pass, so that only the broadcast packets within the VLAN range may be span-ring broadcast. Therefore, it is guaranteed that the intersection of the VLAN ranges of the broadcast packets allowed passing the Station A and the station B is empty, in other words, the intersection of the control conditions of allowing span-ring broadcasting for all the intersection stations is empty. For example, if a VLAN range configured on the Station A is 1-2048, then for all the broadcast packets passing the Station A, the span-ring broadcasting of the broadcast packets within the range of 1-2048 may be performed and the broadcast packets within the range of 1-2048 may be inserted to the RPR ring2. A range of 2049-4094 is configured for the station B. After the above configuration and implementation, the broadcast storm is avoided while both station A and station B are ensured to forward span-ring services. The packet forwarding process for the RPR intersection rings according to the embodiment of the present invention shown in FIG. 9 includes the following.

Block 100: A broadcast packet with a VLAN ID of 1000 is inserted to the RPR ring1 from the Station Q and is broadcast in the RPR ring1.

Block 110: The broadcast packet reaches the Station A, and is copied from the Station A while being broadcast in the RPR ring 1.

Block 120: According to the identity information carried in the copied broadcast packet, it is determined that whether the broadcast packet is allowed to be span-ring inserted to the RPR ring2 for broadcasting, in other words, the configuration information on the Station A is searched for judging whether span-ring broadcasting is allowed; if it is allowed, performing the block 130; otherwise, performing the block 170. Since the VLAN ID of the broadcast packet in this embodiment is 1000 and is within the range of 1-2048, the copied broadcast packet is allowed to be inserted to the RPR ring2 and be broadcast in the RPR ring2.

Block 130: The span-ring broadcasting of the packet is allowed, in other words, the copied broadcast packet is inserted to the ring again through layer 2 forwarding and is span-ring inserted to the RPR ring2.

Block 140: When the broadcast packet passes the station B in the RPR ring2, the broadcast packet is copied from the station B while being broadcast in the RPR ring2.

Block 150: According to the identity information carried in the copied broadcast packet, it is determined whether the broadcast packet is allowed to be span-ring inserted to the RPR ring1 for broadcasting, in other words, the configuration information on the Station B is searched for judging whether span-ring broadcasting is allowed; if it is allowed, performing the block 160; otherwise, performing the block 170. In this embodiment, since the VLAN ID of the broadcast packet is 1000 and is not in the allowed range of 2049-4094 of the station B, the broadcast packet is not allowed to be span-ring inserted to the RPR ring1, and jumping to block 170.

Block 160: The span-ring broadcasting of the packet is allowed, in other words, the copied broadcast packet is inserted to the ring again through layer 2 forwarding and is span-ring inserted to the RPR ring2.

Block 170: The copied broadcast packet is discarded.

For the broadcast packet which passes the station B in block 140 and is broadcast in the RPR ring2, when the broadcast packet comes back to Station A in the RPR ring2, the broadcast packet is stripped by the Station A because the Station A is a source station and the broadcast packet is inserted to the RPR ring2 from the source station. Thus, the broadcast for the span-ring service is finished.

In the RPR ring1, for the broadcast packet which passes the station A in block 110 and is broadcast in the RPR ring 1, when the broadcast packet passes the station B, it is also necessary to determine whether the span-ring broadcasting of the broadcast packet is allowed. The principle is same as above, and the description thereof will not be repeated.

The VLAN ID is taken as an example for illustration. Other control conditions may also be used, such as the MAC address information, RPR ID, IP address information and any combination thereof.

After the implementation the method according to the embodiment of the present invention, the path for broadcasting the broadcast packet between the RPR intersection rings is shown as FIG. 10. Taking the station A in the RPR ring 1 as an example, after the broadcast packet is inserted to the ring from the Station Q, the broadcast packet is broadcast in the RPR ring 1 first. When the broadcast packet reaches station A, the broadcast packet is copied and the copied broadcast packet is span-ring inserted to the RPR ring2 to be broadcast in RPR ring2. When the broadcast packet reaches station B, the broadcast packet is copied, but the broadcast packet is not allowed to be span-ring inserted to the RPR ring 1 by the station B. Hence, the broadcast packet is discarded. When the broadcast packet being broadcast in the RPR ring2 comes back to the source station A, the broadcast packet is stripped. The processing of the station B is the same as that of the Station A.

The method according to the embodiment of the present invention may also be applied to a networking structure with a plurality of RPR rings intersected. The forwarding process for a packet by the intersection stations is similar to that in the above description.

It can be understood by those skilled in the art that all or part of the blocks in the method according to the above embodiment may be implemented through instruction of relevant hardware by a program. The program may be stored in a computer readable storage medium, such as ROM/RAM, diskette and optical disc.

It is obvious that in the embodiment of the present invention, the span-ring service packets are forwarded at each of the intersection stations of the RPR intersection rings, so that each intersection station processes packets with different VLAN ranges. Hence, the pressure on forwarding packets to each other by intersection stations is reduced and the load balancing of the span-ring services is achieved. Meanwhile, because the intersection stations implement a control strategy for the span-ring broadcasting of the packets, the span-ring broadcast storm is avoided.

It is evident that those skilled in the art may make various changes and modifications to the present invention without departing from the spirit and scope thereof. Therefore, the present invention is intended to include these changes and modifications falling within the scope of the appended claims and equivalents thereof.

1. A method for forwarding a packet of resilient packet intersection rings, comprising:
receiving, by an intersection station, a broadcast packet from a first resilient packet ring and copying the broadcast packet to generate a new broadcast packet; and
judging, by the intersection station, whether a copied broadcast packet is allowed to be span-ring inserted to a second resilient packet ring for broadcasting according to identity information carried in the copied broadcast packet; if it is allowed, span-ring inserting the broadcast packet to the second resilient packet ring for broadcasting; otherwise, discarding the broadcast packet.

2. The method according to claim 1, wherein judging by the intersection station whether the copied broadcast packet is allowed to be span-ring inserted to the second resilient packet ring for broadcasting according to the identity information carried in the copied broadcast packet comprises:
if the identity information of the broadcast packet matches a control condition for allowing crossing rings and broadcasting configured in the intersection station, allowing the broadcast packet to be span-ring inserted to the second resilient packet ring for broadcasting; otherwise, not allowing the broadcast packet to be span-ring inserted to the second resilient packet ring for broadcasting.

3. The method according to claim 1, wherein judging by the intersection station whether the copied broadcast packet is allowed to be span-ring inserted to the second resilient packet ring for broadcasting according to the identity information carried in the copied broadcast packet comprises:
if the identity information of the broadcast packet matches a control condition for allowing crossing rings and broadcasting configured in the intersection station, not allowing the broadcast packet to be span-ring inserted to the second resilient packet ring for broadcasting; otherwise, allowing the broadcast packet to be span-ring inserted to the second resilient packet ring for broadcasting.

4. The method according to claim 1, wherein the identity information carried in the broadcast packet comprises at least one of: a Virtual Local Area Network Identity, a Media Access Control address, a Resilient Packet Ring Identity and an Internet Protocol address.

5. The method according to claim 1, wherein an intersection of control conditions for allowing cross rings and broadcasting of all intersection stations on the resilient packet ring intersection ring is empty.

6. The method according to claim 5, further comprising:
broadcasting, by the intersection station, the broadcast packet in the first resilient packet ring.

7. A device for forwarding a packet of resilient packet intersection rings, comprising a configuration layer, a transport layer, a control layer and a forwarding layer, wherein the control layer further comprises a span-ring broadcast control module, the configuration layer is adapted to distribute configuration information to the span-ring broadcast control module in the control layer, when the broadcast packet is transmitted into the control layer from the transport layer, the span-ring broadcast control module in the control layer determines whether the broadcast packet is allowed to be span-rings broadcast according to the configuration; if it is allowed, proceeding to the forwarding layer; otherwise, discarding the broadcast packet.

8. The device according to claim 7, wherein the device for forwarding the packet of the resilient packet intersection ring is a layer 2 network device or a layer 3 network device.

9. The device according to claim 7, wherein the span-ring broadcast control module is adapted to create a span-ring broadcast control table according to the configuration and determine whether to allow crossing rings, the span-ring broadcast control table comprising at least one of a Virtual Local Area Network Identity information, a Media Access Control address information, a resilient packet ring identity information and an Internet Protocol address information.

10. The device according to claim 7, wherein the span-ring broadcast control module comprises at least one span-ring broadcast control table.

11. A device for forwarding a packet of resilient packet intersection rings, comprising:
a packet receiving unit adapted to receive a broadcast packet from a first resilient packet ring;
a packet copying unit adapted to copy the broadcast packet to generate a new broadcast packet;
a packet forwarding unit adapted to insert the new broadcast packet to a second resilient packet ring for broadcasting;
wherein, the device further comprises:
a span-ring broadcast control unit adapted to control the packet forwarding unit to determine whether to insert the new broadcast packet to the second resilient packet ring for broadcasting according to identity information carried in a copied broadcast packet.

12. The device according to claim 11, wherein the device further comprises:
a configuration unit adapted to distribute configuration information to the span-ring broadcast control unit, the configuration information comprising a control condition for allowing the broadcast packet to cross rings and be broadcast.

13. The device according to claim 11, wherein the device is a layer 2 network device or a layer 3 network device.
